(19) United States
(12) Patent Application Publication
(10) Pub. No.: US 2019/0393568 A1
(43) Pub. Date: Dec. 26, 2019

(54) BATTERY HEATING SYSTEM

(71) Applicant: Hardworking American, LLC, Avon, CO (US)

(72) Inventors: Zachery Lewis, Waipahu, HI (US); Adele Keating, Avon, CO (US)

(73) Assignee: Hardworking American, LLC

(21) Appl. No.: 16/447,197

(22) Filed: Jun. 20, 2019

Related U.S. Application Data
(60) Provisional application No. 62/687,668, filed on Jun. 20, 2018.

(51) Int. Cl. H01M 10/615; H01M 10/623; H01M 10/63

(52) U.S. Cl. CPC H01M 10/615; H01M 2220/30; H01M 10/63; H01M 10/623

(57) ABSTRACT

Disclosed is a battery preservation device for preventing rapid depletion of battery life of an electronic device. The electronic device includes a heating element. The battery preservation device in the preferred embodiment includes a battery, a charger, a temperature switch, a temperature sensor and a manual switch. In an embodiment, the battery provides power output needed for heat and duration. Further, the battery is placed at a distance from the heating element. The charger regulates the rate that the battery charges and further the charger prevents the battery from overheating. In an embodiment, the temperature switch is programmed to turn on at a pre-defined low temperature and turn off again at a pre-defined high temperature. Further, the temperature switch prevents overheating of the battery. In an embodiment, the temperature sensor is positioned equidistant to the heating element as the battery, the temperature sensor estimates the temperature of the battery. In an embodiment, the manual switch configured with the temperature sensor for allowing the user to switch power between at least one of the heating element; and the temperature switch. The manual switch turns the electronic device on when exposed to cold temperatures and off when exposed to higher temperatures on the action caused by the user. Further, the manual switch prevents rapid depletion of battery life by dissipating the heat.

### CROSS-REFERENCE TO RELATED APPLICATIONS

This application claims benefit under 35 U.S.C. 119(e) of U.S. Provisional Application Ser. No. 62/687,668, filed Jun. 20, 2018, which is hereby expressly incorporated herein by reference in its entirety.

### FIELD OF THE INVENTION

The present invention is directed to a system for heating a battery. In particular, embodiments of the invention surround an apparatus and method for heating one or more batteries associated with or otherwise integrated within portable electronic devices.

### BACKGROUND OF THE INVENTION

Demand for lithium batteries for use in portable electronic devices for information communications such as personal digital assistants (PDAs), mobile phones, or notebook computers, electrical bicycles, and electrical vehicles is increasing, and development of small and lightweight electrical devices has led to commercialization of small lithium batteries that can be charged and discharged with high capacity. However, a variety of problems associated with lithium batteries utilized in portable electronic devices remain in association with their sensitivity to the external environment.

A typical lithium battery includes a positive electrode, a negative electrode, each of which includes an active material enabling intercalation and deintercalation of lithium ions, and an organic electrolytic solution or a polymer electrolytic solution which fills a space between the positive electrode and the negative electrode, and generates an electrical energy due to an oxidation-reduction reaction occurring when lithium ions are intercalated into and/or deintercalated from the positive electrode and the negative electrode.

When battery terminals are connected, a chemical reaction is initiated that generates electrons to supply the current of the battery. Batteries that experience lowered temperature experience chemical reactions that proceed more slowly. Therefore, if a battery is used at a low temperature, such as when used in association with a personal electronic device during a cold winter sports activity, less current is produced by the battery than otherwise would be at a higher temperature. As the batteries run down, they quickly reach the point where they cannot deliver enough current to keep up with the demand.

At present, conventional temperature regulation modes for battery packs include methods of dissipating heat by use of air convection. Such the mode of using a heat sink to conduct heat out of the battery pack and then lowering the temperature by using the convection action of surrounding air. However, such methods may require additional provision of a convection wind channel, a fan or a heat sink proximal to the battery pack, which increases the size of the battery pack and associated structures. The structures contemplated in association with such solutions make them impractical for use in association with a personal mobile electronic device.

Therefore, a need remains for a battery preservation device designed to apply heat to the vicinity of the battery without excess bulk. Further, the battery preservation device should offset the ambient temperature and prevents the slowing of the chemical reaction that leads to rapid depletion of battery life.

### SUMMARY OF THE INVENTION

In accordance with teachings of the present invention, a battery preservation device for preventing rapid depletion of battery life due to exposure to suboptimal external temperatures is provided. The present inventor has recognized that, in the preferred embodiment, it is advantageous to integrate at least one battery, a battery charger, a manual switch and a temperature switch onto a circuit board having a width dimension of no greater than two inches and a length dimension of no greater than four inches, and a height dimension of no greater than one-third inch, configured such that leads to connect to at least one heating element positioned to heat an object partially enclosed by the battery preservation device.

An object of embodiments of the present invention is to prevent rapid depletion of battery life by utilization of an electronic device. The electronic device includes a heating element. In an embodiment, the heating element comprises a heating pad. In an embodiment, the heating pad is configured to fit within a 5 centimeter squared application. In an embodiment, the heating pad is configured to receive 5 volts of direct current through a polyester filament and micro metal conductive fiber folded into a protective polyimide film. In an embodiment, the heating pad is configured to safely allow for near-body heating applications. The preferred embodiment of the present invention, comprising a battery preservation device, includes a battery, a charger, a temperature switch, a temperature sensor and a manual switch.

The present inventor has recognized the potential application of embodiments of the present invention to a variety of electronic devices. In varying embodiments, the battery preservation device may be configured to accommodate and work with phones, tablets, computers, and portable global positioning system (GPS) devices.

In an embodiment of the invention, the battery preservation device comprises at least one battery, which provides power output needed for heat. In an embodiment, the battery is connected to the battery of an associated personal electronic device and can enhance the duration of life available to the associated personal electronic device. Further, the battery is placed at a distance from the heating element. In an embodiment, the battery comprises a lithium ion battery configured to output 3.7 volts at 2000 mAh. In an embodiment, the battery incorporates built-in protection against over voltage, over current, and minimum voltage. In an embodiment, the battery is configured to maintain a slim and lightweight profile to enable it to fit within a substantially flat, low profile casing suitable to surround a portable electronic device.

In an embodiment, the battery preservation device comprises a charger, which regulates the rate that the battery charges. Further the charger incorporates a mechanism to prevent the battery from overheating. In an embodiment of the invention, the charger comprises a Micro-USB charger as known and recognized by one skilled in the art. In an embodiment, the charger comprises a charger configured to charge 3.7 volt LiPo cells at a rate of 500 milliamps. In various embodiments, the charger may be configured to charge single cell lithium ion or lithium polymer batteries.

In an embodiment, the battery preservation device incorporates a temperature switch. In an embodiment, the temperature switch incorporates an embedded central processor chip communicatively linked to built-in automatic memory facilitating the ability to control temperature to an accuracy of within 4 degrees Celsius. In an embodiment, the temperature switch is programmed to turn on at a pre-defined low temperature and turn off again at a pre-defined high temperature. In an embodiment, the temperature switch comprises a measurement input as known by one skilled in the art. In an embodiment, the measurement input may comprise a NTC (10K 0.5%) waterproof sensor. Further, the temperature switch incorporates a mechanism to prevent overheating of the battery.

In an embodiment, the battery preservation device incorporates a temperature sensor. In an embodiment, the temperature sensor comprises the measurement input for the temperature switch. In an embodiment, the temperature sensor is positioned at a distance to the heating element as the distance from battery to the heating element. The temperature sensor estimates the temperature of the battery. The manual switch configured with the temperature sensor for allowing the user to switch power between at least one of the heating element; and the temperature switch.

In an embodiment, the battery preservation device incorporates a manual switch, which turns the electronic device on and off. In an embodiment, the manual switch comprises a general control switch as known by one skilled in the art. The present inventor contemplates that a user will utilize the manual switch to turn the device on when exposed to cold temperatures and off when exposed to higher temperatures. In an embodiment of the invention, the manual switch comprises a mountable slide switch as known by one skilled in the art. In an embodiment, the switch is configured to be rated for 300 mA at 125 VAC. Further, in an embodiment, the manual switch prevents rapid depletion of battery life by dissipating the heat. In an embodiment, the manual switch may be configured to toggle power delivery to the temperature switch.

Another object of the present invention is to provide the battery preservation device with mode where manual switch turns directly to the heating element on identifying the less temperature.

### BRIEF DESCRIPTION OF DRAWINGS

FIG. 1 is a block diagram illustrating a battery preservation device for preventing rapid depletion of battery life in accordance with the present disclosure.

FIG. 2 is another block diagram for illustrating a battery preservation device for preventing rapid depletion of battery life in accordance with the present disclosure.

FIG. 3A is a perspective view of the battery preservation device constructed in accordance with the present disclosure.

FIG. 3B is a perspective view of the battery preservation device constructed in accordance with the present disclosure.

FIG. 4A is a see through side elevation view of the battery preservation device constructed in accordance with the present disclosure.

FIG. 4B is a side cut view of the battery preservation device constructed in accordance with the present disclosure.

FIG. 5 is an exploded view of the battery preservation device constructed in accordance with the present disclosure.

### DETAILED DESCRIPTION

While the specification concludes with claims defining the features of the invention, a battery preservation device for preventing rapid depletion of battery life will be better understood from a consideration of the following description in conjunction with the figures. The detailed embodiments of the present invention have been included herein. However, it must be understood that the disclosed embodiments are merely exemplary of the invention, which may be embodied in various forms. Therefore, the structural and functional details that have been disclosed should not be interpreted as limiting. They must merely be taken as the basis for the claims and as a representative basis for teaching one skilled in the specific domain to variously employ the present invention in virtually any appropriately detailed structure. Further, the terms, phrases and examples used herein are not intended to be limiting, but are rather intended to provide an understandable description of the invention.

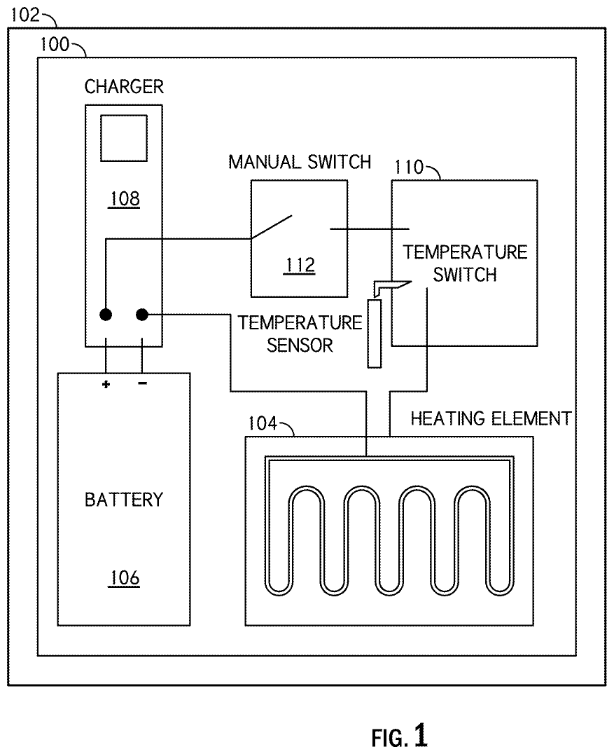

FIG. 1 depicts a block diagram illustrating a battery preservation device 100 for preventing rapid depletion of battery life in an electronic device 102 in accordance with a preferred embodiment of the present invention. The electronic device 102 incorporates a heating element 104. In one embodiment, the electronic device 102 can be a phone. The battery preservation device 100 includes a battery 106, a charger 108, a temperature switch 110, a manual switch 112 and a temperature sensor 114.

In an embodiment, the battery 106 provides power output needed for heat and duration. The battery 106 is placed at a distance from the heating element 104 to avoid direct contact with the heating element, but is as close as possible to the heating element 104 without posing the risk of overheating. In a preferred embodiment of the present invention, the battery comprises a lithium ion battery that produces a 3.7 Volt current with 2000 mAH.

However, it would be readily apparent to those skilled in the art that various types of lithium ion batteries may be envisioned without deviating from the scope of the present invention. In varying embodiments of the invention, the present inventor has recognized that as the mAH proceeds higher, the duration of operating time is extended. The charger 108 is designed to regulate the rate that the battery 106 charges. Further, the charger 108 prevents the battery 106 from overheating and failing.

The temperature sensor 114 is positioned equidistant to the heating element 104 as to the battery 106. The temperature sensor 114 estimates the temperature of the battery 106. Further, the temperature sensor 114 is to be positioned with similar material conditions between the battery 106 and the heating element 104 to accurately estimate the temperature.

The temperature switch 110 configured with the temperature sensor 114 is programmed to turn on at a pre-defined low temperature and turn off again at a pre-defined high temperature. Further, the temperature switch 110 prevents overheating of the battery 106. The temperature switch 110 prolongs the battery life of the electronic device 102.

The manual switch 112 switch allow the user to switch power between the heating element 104 and the temperature switch 110. Further, the manual switch 112 turns the electronic device 102 on when exposed to cold temperatures and off when exposed to higher temperatures.

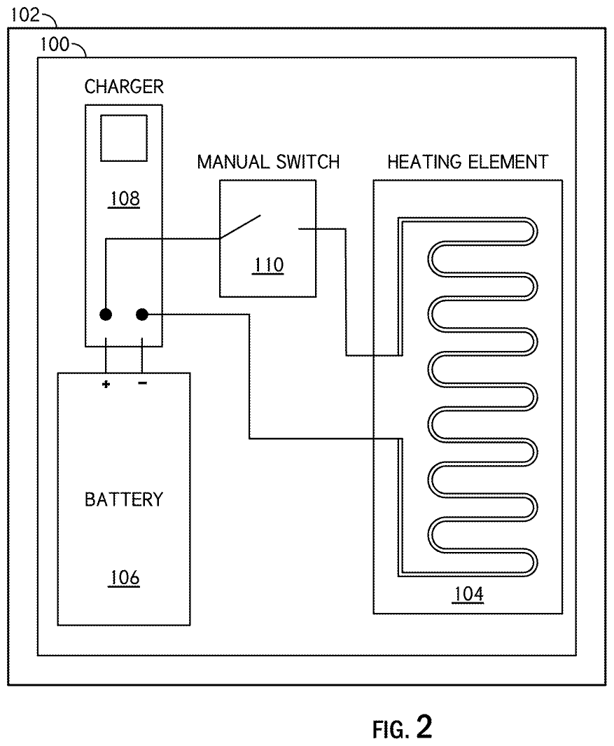

In one embodiment as shown in FIG. 1, the manual switch 110 turns on the temperature switch 110 on the action caused by the user. Thus, the manual switch 110 prevents rapid depletion of battery 106 life by dissipating the heat. The switching of the manual switch 112 towards the heating element 104 is explained and shown in detail in conjunction with FIG. 2 of the present invention.

FIG. 2 illustrates another block diagram of battery preservation device 100 in accordance with another preferred embodiment of the present invention. As shown in the FIG. 2, the manual switch 110 turns on the heating element 104 when the electronic device 102 is exposed to cold temperatures.

The heating element 104 is placed close to the subject battery 106. It would be readily apparent to those skilled in the art that the battery preservation device 100 may be created in various shape and sizes depending upon the size of the electronic device 102. The heating element 104 with small size requires less voltage to reach higher temperatures and with bigger sizes require high voltage to reach higher temperature. Examples of the electronic device 101 include but are not limited to cell phones, tablets, laptops, GPS's, Radios, Standalone batteries and similar devices.

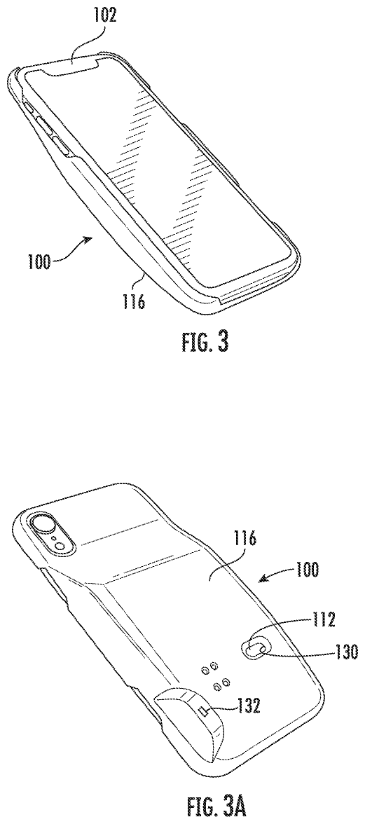

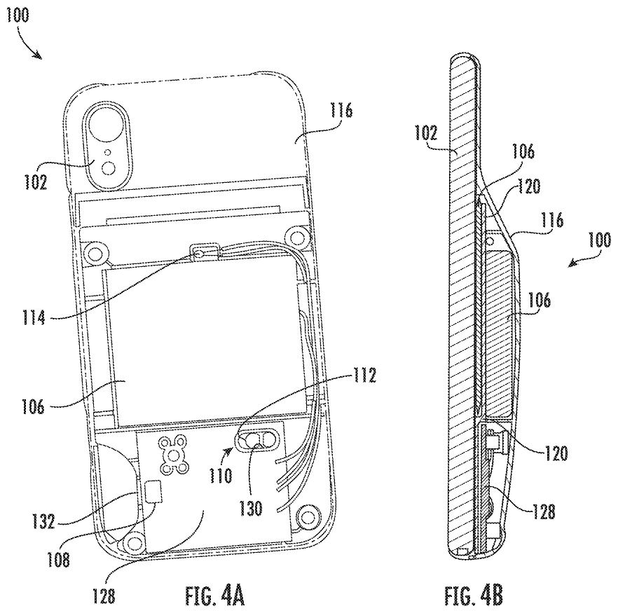

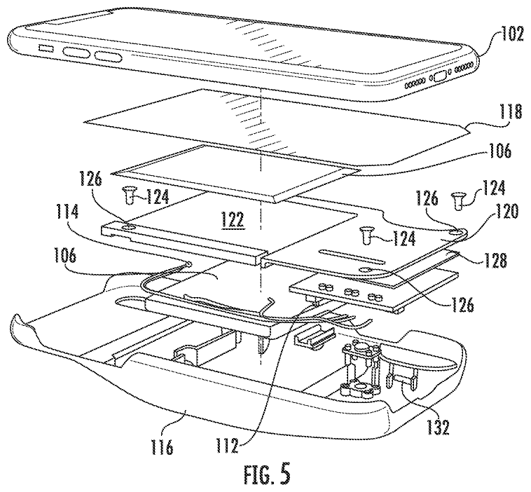

An exemplary embodiment of the battery preservation device 100 is shown in FIGS. 3A-5. In this exemplary embodiment, the battery preservation device 100 also includes a housing 116 for securing the battery preservation device 100 to the electronic device 102. The housing 116 can be secured to the electronic device 102 in any manner known in the art. For example, the housing 116 can be snap fitted on the electronic device 102. The housing 116 encapsulates most of the other components of the battery preservation device 100 and secures them in close proximity to the electronic device 102. The housing 116 can have the requisite number of openings and size of openings to cooperate with various types of electronic devices 102.

The battery preservation device 100 can also include a protective liner 118 disposed immediately adjacent to the electronic device 102 and between the heating element 104 (or heater) and the electronic device 102. The battery preservation device 100 can also include a securing plate 120 to hold the heating element 104 in place against the protective liner 118. The securing plate 120 is disposed between the battery 106 and heating element 104. The securing plate 120 can have an indented portion 122 for receiving the heating element 104 and preventing lateral movement of the heating element 104 inside the battery preservation device 100. The securing plate 120 can also be secured to the housing 116 via screws 124 that extend through openings 126 in the securing plate 120.

The housing 116 can include a cavity area to provide space for the the battery 106, which is disposed between the securing plate 120 and the housing 116. A printed circuit board (PCB) 128 can be disposed in the cavity area with the battery 106. The battery preservation device 100 can also include a programmable logic controller (PLC), supported by the PCB, to coordinate the workings of the battery 106, the charger 108, the temperature sensor 114, the temperature switch 110, the manual switch 112 and the heating element 104.

The housing 116 can include an opening 130 disposed therein for the manual switch 112 to extend through and have space to toggle between different operating positions. The housing can also include another opening 132 for access to the charger 108 with a charging cord to charge the battery 106.

The present application provides various advantages such as usage with any handheld or portable or electronic device that is exposed to temperatures resulting in rapid battery loss. The present invention further offer usage with any waterproof container and pressure-resistant container to prolong the life of any battery powered electronics exposed to cold water. Further, the present invention may be arranged and integrated into any product prior to manufacturing or be combined with an aftermarket housing that allows the user to use the device when applicable or remove when not required.

The many features and advantages of the invention are apparent from the above description. Many changes, modifications, variations and other uses and applications of the subject invention will, however, become apparent to those skilled in the art after considering this specification and the accompanying drawings which disclose the preferred embodiments thereof. All such changes, modifications, variations and other uses and applications which do not depart from the spirit and scope of the invention are deemed to be covered by the invention, which is to be limited only by the claims which follow.

What is claimed:

1. A battery preservation device for preventing the rapid depletion of battery life in an electronic device, comprising:
a heating element;
a battery configured to provide power output necessary to generate for heat, the battery placed at a distance from the heating element;
a charger configured to regulate the rate that the battery charges, the charger further configured to prevent the battery from overheating;
a temperature switch configured to turn on at a pre-defined low temperature and turn off again at a pre-defined high temperature;
a temperature sensor positioned equidistant to the heating element as the battery, and a manual switch configured to allow a user to switch power between at least one of the heating element and the temperature switch.

2. The battery preservation device of claim 1, the temperature switch further configured to prevent overheating of the battery.

3. The battery preservation device of claim 1, the temperature sensor configured to detect the temperature of the battery.

4. A battery preservation device for preventing the rapid depletion of battery life in an electronic device, the device comprising:
a housing for encapsulating various components of the battery preservation device and securing the battery preservation device;
a heating element disposed within the housing of the battery preservation device;
a protective layer disposed between the heater and the battery preservation device;
a securing plate disposed on the opposite side of the heating element from the protective layer; and
a battery disposed on the opposite side of the securing plate from the heating element.

5. The battery preservation device of claim 4 further comprising:
a charger configured to regulate the rate that the battery charges, the charger further configured to prevent the battery from overheating;
a temperature switch configured to turn on at a pre-defined low temperature and turn off again at a pre-defined high temperature;
a temperature sensor positioned equidistant to the heating element as the battery, and a manual switch configured to allow a user to switch power between at least one of the heating element and the temperature switch.

6. The battery preservation device of claim 4 further comprising a PCB and a PLC to support the functioning of the battery preservation device.

7. The battery preservation device of claim 4 wherein the securing plate includes a recessed area for accepting the heating element and to prevent the lateral movement of the heating element inside the battery preservation device.

8. The battery preservation device of claim 4 wherein the securing plate is securely fastened to the housing.

9. The battery preservation device of claim 4 wherein the housing is selectively securable to the electronic device via a snap fit or frictional engagement.

10. The battery preservation device of claim 5 further comprising an opening disposed in the housing to permit a charging cable access to the charger.
